(19) United States
(12) Patent Application Publication
(10) Pub. No.: US 2024/0336453 A1
(43) Pub. Date: Oct. 10, 2024

(54) THREAD TRAVERSING DEVICE, TEXTILE MACHINE AND METHOD

(71) Applicant: Saurer Spinning Solutions GmbH & Co. KG, Übach-Palenberg (DE)

(72) Inventor: Michael Spitzer, Monschau-Kalterherberg (DE)

(73) Assignee: Saurer Spinning Solutions GmbH & Co. KG, Übach-Palenberg (DE)

(21) Appl. No.: 18/622,898

(22) Filed: Mar. 30, 2024

(30) Foreign Application Priority Data
Apr. 5, 2023 (LU) 503858

(51) Int. Cl. B65H 54/06; B08B 5/04; B65H 54/22; B65H 54/70; B65H 57/00

(52) U.S. Cl. CPC B65H 54/06; B08B 5/04; B65H 54/22; B65H 54/702; B65H 57/006; B65H 2406/30; B65H 2701/31

(57) ABSTRACT

A thread traversing device for a winding device of a textile machine producing cross-wound bobbins including a thread guide housing having a thread guide, and a traversing device to reversibly traverse along a direction of axis of the cross-wound bobbin to be produced. At least one vacuum system comprising at least one fluid guide is provided, wherein the thread guide housing is designed and wherein the traversing device is associated with the thread guide housing so as to, in a work station of the textile machine, reversibly traverse the thread guide along a direction of the axis of rotation of the cross-wound bobbin to be produced, and wherein the thread guide housing can be brought into fluidic communication with the fluid guide in order to apply a vacuum to the thread guide housing.

The invention relates to a thread traversing device for a winding device of a textile machine producing cross-wound bobbins. The invention further relates to a thread guide housing, in particular for a thread traversing device. The invention further relates to a textile machine. The invention relates to a method for cleaning a thread guide and/or a thread guide housing. The invention further relates to a control device.

Thread traversing devices are known and are used in the production of cross-wound bobbins by reversibly traversing a thread guide between two states. It is known that, on the one hand, the textile bobbin in question is set in rotation and, on the other hand, the thread running onto the bobbin traverses relatively quickly along the bobbin axis during the winding process. As a result, the guided thread is wound onto the cross-wound bobbin, or a pre-placed core, as a result of which a cross-winding occurs which is caused by the traversing. This provides densely packed bobbins which also have a stable winding. Furthermore, the resulting textile bobbins can unwind particularly well, i.e. the thread can be unwound particularly well by machine, but does not fall off the roll by itself. Here the traversing takes place in particular in a direction of movement parallel to an axis of rotation of the cross-wound bobbin. An angled movement is also conceivable. Textile machines that use this technology include spinning machines and/or twisting machines.

A thread traversing device is known from DE 10 2004 003 173 A1. A thread traversing device for a winding device of a textile machine producing cross-wound bobbins is described therein. The thread traversing device has a thread guide which is guided in the region of the work station on a thread guide rod and is connected to an individual drive via an endless traction means. Here it is provided that the thread traversing device has a largely closed housing, the interior of which in the traversing region of the thread guide is sealed by the endless traction means.

The spinning process, but also the abrasion of thread and/or yarn during the production of the cross-wound bobbin, can lead to impurities in the winding device, which however can also be introduced into the thread traversing device. This can result in impairments in the production of cross-wound bobbins, which increases service life of the machines for maintenance and repair. Furthermore, the production of the final product, the cross-wound bobbins, can be impaired.

The object of the invention is therefore to improve the quality of the production of cross-wound bobbins, to increase the reproducibility of their production, and to increase the reproducibility of the resulting cross-wound bobbins, and to minimize down times and thereby to save resources.

The object is achieved by a thread traversing device having the features of claim 1. The object is further achieved by a thread guide housing having the features of claim 10. The object is further achieved by a textile machine having the features of claim 11. The object is further achieved by a cleaning method having the features of claim 12. The object is achieved by a control device having the features of claim 14.

Advantageous embodiments of the invention are the subject matter of the dependent claims.

According to one aspect, the object is achieved by a thread traversing device having the features of claim 1.

A thread traversing device can have a thread guide housing for a winding device of a textile machine producing cross-wound bobbins. The thread guide housing can have a thread guide. The thread guide housing can have a traversing device which is designed and arranged to reversibly traverse along a direction of the axis of the cross-wound bobbin to be produced. At least one vacuum system can be formed and arranged, wherein the vacuum system has at least one fluid guide. Here the thread guide housing can be designed and the traversing device associated with the thread guide housing so as to, in a work station of the textile machine, reversibly traverse the thread guide along a direction of the axis of rotation of the cross-wound bobbin to be produced. The thread guide housing can be brought into fluidic communication with the fluid guide so as to apply a vacuum to the thread guide housing. The quality of the cross-wound bobbin production can thereby be improved. Furthermore, the reproducibility of the production of the bobbins can be improved, and the reproducibility of the resulting cross-wound bobbins can be increased. It is thereby possible to minimize down times and thereby to save resources.

A traction device, in particular an endless traction device, can be provided as a traversing device, as is described elsewhere. Alternatively, a traversing device can also have a traction rod and/or a traction plate as a traction device, with which a thread guide is connected in such a way as to enable a lifting movement of the thread guide largely parallel to the axis of rotation of the cross-wound bobbin or from its core. In this context, “largely parallel” means that an angled geometry—angled relative to the axis of rotation of the cross-wound bobbin in one operation—can also be provided. The maximum angle here can be an angle that enables a conical cross-wound bobbin. The minimum angle here is in particular a parallel movement to the axis of rotation and results in a cylindrical cross-wound bobbin.

Thread traversing devices are in particular outwardly delimited by a thread guide housing. The traversing device can thereby oscillate in the thread traversing device in order to thereby impress a lifting movement on the thread guide. The thread guide can thereby be moved from one side of the thread traversing device to another side of the thread traversing device.

In one embodiment, the thread traversing device can have a thread guide which is mounted so as to be guidable on at least one thread guide rod In the region of a work station of a textile machine. Here the guide can be connected to an individual drive via an endless traction means. The thread traversing device has a largely closed housing, the interior of which is sealed in the traversing region of the thread guide. This sealing can be done in particular by the endless traction means. This embodiment can be easy to implement. A simple mechanism can be implemented in order to form the traversing device.

A fluid pump, in particular a vacuum pump, can be provided as a vacuum system. This vacuum system can be connected to the thread traversing device by means of a fluid guide in such a way as to establish a fluidic communication between the vacuum system and the thread traversing device.

A fluid guide is designed in particular so as to be able to guide a fluid in order to be able to apply a vacuum. A fluidic communication represents a connection, as a result of which an exchange of information can be indirectly transmitted via a fluid column in a fluid guide.

According to one aspect, the vacuum system can have a suction nozzle. The suction nozzle can in particular be designed as a stationary suction nozzle. The suction nozzle is in particular designed and arranged in such a way as to find a thread end on the cross-wound bobbin. The suction nozzle is here in particular connected to the at least one fluid guide in order to form a fluidic communication with the suction nozzle. Here the thread guide housing can in particular be reversibly brought into fluidic communication with the fluid guide in a state. The quality of the cross-wound bobbin production can thereby be improved. In the event of a breaking of the thread, the production no longer necessarily has to be interrupted; rather, devices and means can be provided in order to bring about a new taking up of the thread end and to transfer a thread back into a spinning process and to resume the production of the cross-wound bobbin. The occurrence of unfinished cross-wound bobbins can thereby be reduced, since production can be resumed. This conserves resources and reduces the occurrence of rejects. Furthermore, the reproducibility of the production of cross-wound bobbins can be improved. The reproducibility of the resulting cross-wound bobbins can also be increased.

The term “fluid” is to be understood in particular as a fluid that surrounds the thread traversing device and/or in particular that fills the thread guide housing and/or the suction nozzle at least at the beginning of the application of a vacuum. This fluid can preferably be air, in particular dry air, artificial air, nitrogen, but also ambient air.

In particular, a suction nozzle is a device that enables a pick-up region for a thread to be brought up to a surface of a cross-wound bobbin in such a way that a thread is at least partially suctioned into the pick-up region. This can be enabled by applying a vacuum to the suction nozzle. In particular, a thread end of a broken thread which has been pulled onto the cross-roller by the rotation thereof is drawn into the suction nozzle. The suction nozzle can thereby serve to pick up a broken thread end from the cross-roller in order to supply this thread end for a new piecing. As a result, in particular the cross-roller is not made defective by the fact that the thread is broken. Rather, a device can be provided to catch a thread and thus to resume the production of the cross-wound bobbin (also known as a cross-roller). In particular, cross-wound bobbins with reproducible, in particular identical, diameters can thus be produced, wherein the diameter can be defined in a fixed manner.

According to one aspect, the thread traversing device can have an air duct. This air duct can be an air duct which is designed in particular as a stationary air duct. This air duct can be formed and arranged to supply the thread to the thread guide in a production state. A guided thread feed can thus be provided, and the thread can be supplied to a cross-roller.

The air duct can have an opening into which the thread is inserted into the air duct. The thread in particular starts from a spinning station in which the thread can be produced. The thread is guided through at least one part of the air duct and is guided out at one end of the air duct, in particular to be fed via the thread guide to a thread traversing device at a work station of a cross-wound bobbin.

A production state can correspond to a state in which a cross-wound bobbin is produced. In particular, a traversing device can traverse a thread guide in order to be able to wind the cross-wound bobbin.

In contrast, a non-production state can correspond in particular to a thread-seeking state or a piecing state. The fluid guide can be designed and arranged to bring the suction nozzle and the thread guide housing into fluidic communication with the vacuum system.

In this case, the air duct is connectable, in particular in the non-production state, to the at least one fluid guide of the vacuum system in order to form a fluidic communication via the air duct and the fluid guide to a suction nozzle and/or to a thread guide housing. A vacuum can thus be applied to the thread guide housing and/or to the suction nozzle. This can take place in particular simultaneously.

According to one aspect, the fluid guide can be designed as a vacuum duct. A fluidic communication can thereby be provided, by means of which a vacuum can be applied.

The fluid guide, in particular the vacuum duct, can have at least one throttle point. This can in particular be designed as a control valve. As a result, the vacuum can be applied in a controlled manner. In particular, the duration for which the vacuum is applied can be controlled. Alternatively or additionally, the level of the vacuum can also be set and maintained in a controlled manner. The throttle point also allows opening and/or closing to be controlled as required, which saves energy and therefore conserves resources.

Additionally or alternatively, the fluid guide, in particular the vacuum duct, can have a thread clamping device. This can prevent a clogging of the fluid guide, in particular of the vacuum duct, due for example to a broken thread penetrating in an uncontrolled manner, which can at least partially penetrate into the fluid guide through a suction nozzle described above. Furthermore, the thread clamping device can specify a maximum penetration depth of the thread into the vacuum duct. A clogging, of the control valve for instance, can thereby be prevented. Other mechanical damage, for example to the pumps, can also thereby be prevented. This increases the safety of operation of the vacuum source.

Here it can be possible for at least one thread end to penetrate the fluid guide and be held by the thread clamping device in a position that allows the thread to be pulled out again by a device designed for this purpose in order to be linked to a spun thread in order to resume a cross-winding process. The thread clamping device can in particular be designed such that at least one hook and/or at least one eyelet interacts with an inserted thread in the fluid guide, in particular the vacuum duct.

However, the thread clamping device can also be designed and arranged in such a way that the thread is held in tension, even if a vacuum is not to be applied permanently in order to keep the thread tensioned. The tension of the thread can be relevant here in order to enable the thread to be picked up for reattachment to a subsequently supplied thread. Here the subsequently supplied thread can be supplied for example from a spinning station, wherein the broken thread and the new thread can be connected to one another.

The vacuum duct can also be designed to be stationary. In the vacuum duct there can be arranged a throttle point, in particular a control valve, which can be moved from an open state to a closed state. It is thereby possible to apply a vacuum in a controlled manner. The intensity (level) of the vacuum can also be set by the throttle point/the control valve. All parameters of the application of the vacuum can thereby be set and maintained in a controlled manner.

According to one aspect, a closing device can be designed and arranged in such a way as to close a thread entry region into the air duct. This allows the air duct to be closed if no thread can be fed through the air duct. In the event of a thread breakage, a thread end can be suctioned in from the cross-roller by means of a suction nozzle. This makes it possible for the thread that has run onto the cross-roller to be fed back to a piecing process. Here it can also be provided for the broken thread to be able to again be connected to a further thread piece in order to continue the production of the cross-roller. In order to apply a vacuum, in particular the thread insertion region (also called the thread entry region) of the air duct can be closed, for example in order to form sufficient suction force through the suction nozzle to catch a thread.

In particular, a pivotable arm can be provided as a closing device, which has a closing cap and/or a sealing element such that by pivoting it can come into engagement with the thread entry region in order to close it in particular in an airtight or gas-tight manner.

According to one aspect, a thread-catching device can be arranged on the closure device so as to catch a thread region of a thread. It is thereby possible for a thread end to be caught by the cross-wound bobbin even after a thread breakage, for example by a suction nozzle, and wherein the thread is at least partially suctioned into an air duct or also into a vacuum duct.

A thread-catching device can be a hook and/or an eyelet that allows a thread region of a thread to be gripped. The thread region is in particular a thread end. Furthermore, the thread region can be a region of the thread that between a region of the thread that contacts the cross-wound bobbin and a thread end, in particular up to the thread clamping device, which may hold the thread under tension.

According to one aspect, the closure device can be designed and arranged in such a way as to close the thread entry region into the air duct in the non-production state. The fluid guide can be designed and arranged to connect the vacuum system to the air duct in the non-production state, in particular via the fluid guide, in order to form a fluidic communication with the suction nozzle. Here the thread guide housing is formed and arranged in particular in such a way as to be connected to the fluid guide in the non-production state in order to generate a fluid flow through the suction nozzle and simultaneously out of the thread guide housing. A cleaning of the thread guide housing is thereby improved. A simultaneous cleaning can thereby take place which is not separately present from any work steps in an event such as a thread breakage. This can save time and increase the efficiency of the cleaning.

In particular, the non-functional state can be a thread-seeking state or a piecing state, as described in detail.

The fluid flow is in particular a flow of fluid through the suction nozzle. Alternatively or additionally, a flow of fluid through the thread guide housing can be understood as a fluid flow. It is thereby possible for impurities to be discharged from the thread guide housing. To ensure that the fluid flow does not break off, there is in particular a following flow along the pressure gradient, wherein the pressure gradient in particular follows the application of the vacuum. Valves, nozzles and/or structural openings can be arranged in the suction nozzle, and alternatively or additionally in the thread guide housing. A following flow can be made possible by this. In one embodiment, it can be provided in particular that vacuum is not achieved. The vacuum should in particular allow a thread end to be found in the event of a thread breakage, since the thread end can follow the vacuum in the region of the suction nozzle. An evacuation could also cause any oil components of the mechanism of the traversing device in particular to begin to evaporate. Damage to the thread and the cross-wound bobbin could occur as a result. This could also introduce further impurities into the thread guide housing, which could affect performance and also damage the cross-wound bobbin.

According to one aspect, the thread guide housing can have a reversibly closable opening. The thread guide housing can be reversibly brought into a fluidic communication with the suction nozzle and/or with the fluid guide through this closable opening. As a result, it can also be possible to open the opening only for the case in which a vacuum is applied. As a result, impurities can be kept out of the application.

Alternatively or additionally, the thread guide housing can be connectable to the fluid guide via a short-circuit connection. The thread guide housing can thereby also be cleaned independently of an interruption of the winding process. In particular, a cyclic, in particular fixedly defined cleaning can be carried out. This can also be described as cleaning cycles.

Alternatively or additionally, a vacuum can be applied to the thread guide housing independently of a vacuum on a suction nozzle. The thread guide housing can thereby also be cleaned independently of an interruption of the winding process. In particular, a cyclic, in particular fixedly defined cleaning can be carried out. This can also be described as cleaning cycles.

Alternatively or additionally, the fluid flow in the thread guide housing can be maintained by an inflow of fluid into the thread guide housing through a thread guide housing flow device, while a vacuum is applied to the thread guide housing. In particular, an evacuation is thereby prevented. Furthermore, a defined fluid inflow can thereby be specified in order to prevent any fluid from penetrating through actually unsuitable points. The fluid flow can be maintained by at least one opening in the thread guide housing. Alternatively or additionally, the fluid flow can be maintained by at least one nozzle.

In a further embodiment, the vacuum system can be designed so as to apply a vacuum to the thread guide housing from the outside via the fluid guide. This can in particular take place in such a way that, in addition to or alternatively to the previously described thread traversing devices and thread guide housings, a vacuum is applied to the thread guide housing from the outside. In particular, such locations can be selected in order to generate a fluid flow which makes it possible to apply a vacuum to points and/or regions which tend to contamination and/or via which contamination can enter within the thread guide housing, in order thereby to initiate a fluid flow at these locations and/or regions in order to move potential impurities away from these locations and/or regions by means of the resulting fluid flow. In this case, these impurities are in particular suctioned in and thereby in particular disposed of directly.

In particular, the fluid guide can be arranged in such a way as to generate a fluid flow along the thread guide. In addition, in particular a vacuum can be applied to at least one side of the traversing region in order to form a fluid flow which, in particular, runs substantially parallel to the traversing direction and thereby blows around the thread guide and/or the thread guide shoe, in order to keep impurities such as fiber deposits away from the thread guide and/or from the thread guide shoe.

The traversing region is in particular the region in which a traversing of the thread guide takes place along the direction in which the thread guide can be reversibly moved, as the traversing direction.

The thread guide shoe can be a device which allows the thread guide to be attached to the traversing device in such a way that the thread guide follows the movement of the traversing device.

According to an independent aspect, the object is achieved in particular by a thread guide housing for a thread traversing device as described in detail. The previously described features, definitions, effects, and advantages can thereby also be carried over to the thread guide housing.

According to an independent aspect, the object is achieved in particular by a textile machine which has a thread traversing device as described in detail. Alternatively or additionally, the textile machine can have a thread guiding device as described in detail. The previously described features, definitions, effects, and advantages of the thread guide housing, as of the thread traversing device, can thereby be carried over.

According to an independent aspect, the object is achieved in particular by a method for cleaning a thread guide housing. The thread guide housing can in particular be a thread guide housing as described in detail. The method has in particular the step of establishing a fluidic communication between at least one vacuum system and the thread guide housing. The method can have the step of applying a vacuum to the thread guide housing. The above-described features, definitions, effects, and advantages of the thread guide housing, as well as of the thread traversing device, as well as of the textile machine (categories, devices, and system), can be carried over to the described methods.

According to one embodiment, a plurality of vacuum systems can be provided. In this case, one of the vacuum systems can be activated depending on a preceding or subsequent working state in order to apply a vacuum. A vacuum system can be selected in particular depending on the type of the thread.

According to an independent aspect, the object is achieved in particular by a control device which is designed and configured in particular to carry out a method as described in detail. This allows the effects and their advantages and features described in detail to be implemented.

A control device can be a CPU. Furthermore, a storage device can also be provided which comprises possible method instructions, upon execution of a machine-readable code on a control device, in particular a CPU or a processor, in order to carry out one of the methods detailed in detail.

In summary, and in other words, this means that:

Devices, systems, and methods are described in which a thread can be guided from a producing spinning station through an in particular stationary air duct. A thread traversing device can be provided which has a thread guide housing and a traversing device. Here a thread guide can be arranged on the traversing device in such a way that by means of an alternating lifting movement (also referred to as a traversing movement or as oscillation), a thread can be wound in a cross-winding onto a cross-roller (also called a cross-wound bobbin). A winding drum can be provided, which rotates and can drive the cross-wound bobbin, since it contacts it in particular. A suction connection (as a connection to a vacuum source) can be provided, which can be brought into a fluidic communicative connection with a fluid guide, in particular in the form of a vacuum duct. A control valve and/or a clamping device can be provided here. The control valve serves in particular to control the vacuum, both in terms of time and in relation to the strength (the level) of the vacuum. The clamping device can fulfill a plurality of functions, depending on its implementation. Furthermore, a closure mechanism with a thread-catching device can be provided. The thread-catching device can be designed to pull a thread that has been drawn into the air duct from the cross-wound bobbin out of the thread entry region in order to create a new connection with a subsequently supplied thread. For this purpose the thread-catching device can pull the thread out of the thread entry region, in particular by a rotational movement about an anchoring. In some embodiments, a loop can be made in the end of the thread to enable it to be re-linked with a thread that is supplied later.

In the event of an interruption in production, for example due to a thread breakage, the thread can be pulled off the cross-wound bobbin in a backward movement, in that the winding drum initiates a backward movement. At the same time, a vacuum can be applied to the suction nozzle in order to seek the thread end. In particular, the thread entry region is sealed by the closure mechanism. In particular, the thread is suctioned into the suction nozzle by the vacuum, with the control valve fully or partially open. The air duct, in particular the stationary air duct, is in particular connected to the thread guide housing and in particular simultaneously applies suction to the thread guide housing. As a result, collected textile dirt, threads or fibers can be suctioned out of the thread guide housing, effecting a cleaning.

The fluid flow can in particular be an air flow. This can be maintained, for example, by valves provided for this purpose and/or structural openings provided for this purpose and/or nozzles provided for this purpose. These valves, nozzles, and/or structural openings can be flow-optimized. A bore can be formed as a nozzle. The nozzle can in particular also be designed to be closable and openable. The opening and also the degree of opening can be designed here as required. The control can take place in particular electromotively, electrically, mechanically, pneumatically, or by means of the vacuum. Magnetic closures and/or diaphragms can also be provided.

A preparatory piecing process can also be carried out. A thread breakage may be found here, and the rest of the thread is fixed in particular at both ends. This can be achieved in particular by two harmonizing vacuum sources or by a suitably equipped thread clamping device. In addition, a simultaneous cleaning can take place, in particular of the thread guide housing. Alternatively or additionally, a preventative cleaning can also take place. It may be that there is no thread in the system, or a purely preventative cleaning may be carried out even if a thread is present. In these cases the cleaning of the thread guide housing can take place as described elsewhere.

Alternatively or additionally, the thread guide housing can also have not only the above-described vacuum connection. Rather, a separate connection to the vacuum system can (also) be provided. This connection can be referred to as a short-circuit connection. This system can be switched on and off, in particular cyclically, depending on demand.

Alternatively or additionally, a plurality of vacuum systems can be provided, or a separate vacuum system can be provided which can be connected for cleaning purposes. The choice of the vacuum system can be made depending on a thread or depending on the level of dust to be expected. This allows the impurities and dust in particular to be collected separately in appropriate collection chambers.

In the following, exemplary embodiments of the invention are described in more detail with reference to figures, showing schematically and by way of example:

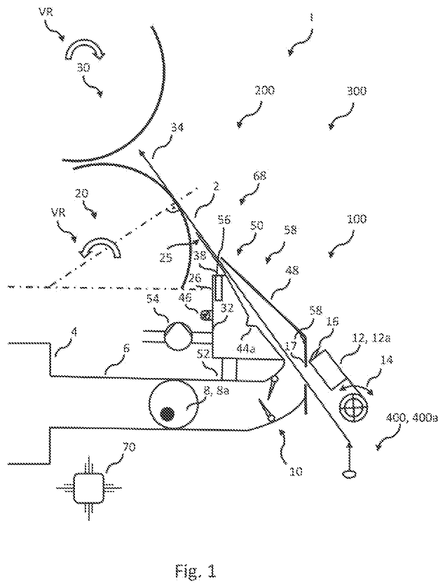

FIG. 1 is a schematic representation of a thread traversing device at a work station of a textile machine in a production state;

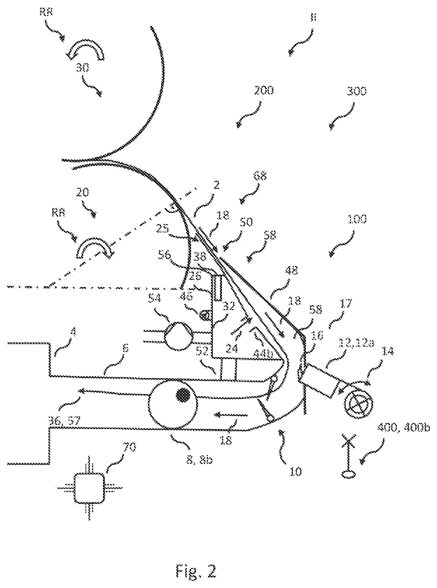

FIG. 2 is a schematic representation of a thread traversing device at a work station of a textile machine in a thread-seeking state;

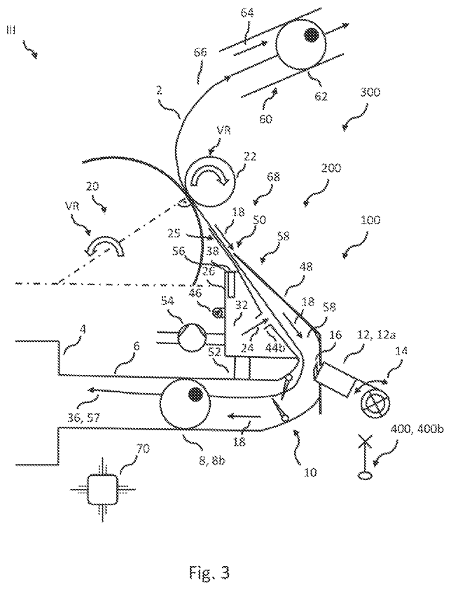

FIG. 3 is a schematic representation of a thread traversing device at a work station of a textile machine in a piecing state; and

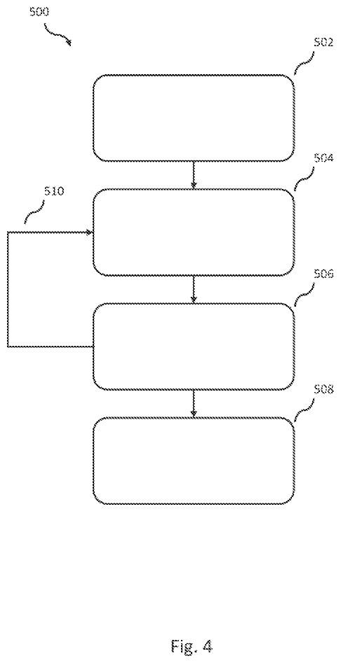

FIG. 4 is a schematic representation of a method for cleaning a thread traversing device.

The same reference signs are used for elements and structures having the same effect and/or of the same type.

FIGS. 1 to 3 show a schematic representation of a textile machine 300, which is arranged and designed in particular to take a thread 2 from a spinning device 400 in production state I, with active spinning device 400a, and to feed it to a cross-wound bobbin 30 by means of a thread traversing device 100 via a winding drum 20 in order to carry out a cross-winding on the cross-wound bobbin 30. This is by way of example a spinning machine, but there are also other textile machines to which these functions and structures can be carried over.

In textile machines 300 for the production of cross-wound bobbins 30, as described at the beginning, a regenerated thread or a coarse yarn with a high short fiber content of, for example, 1 mm in length can lead to impurities, in particular in a thread guide housing 32 or at the thread guide 25. This can lead to deposits on the cross-wound bobbins 30, which impair the quality of these cross-wound bobbins 30. The impurities accumulate at various points of the thread guide 25 or in the thread guide housing 32 of a thread traversing device 100. As a result, time-consuming and therefore resource-intensive cleaning may be necessary to restore the initial quality of the cross-wound bobbins 30.

FIG. 1 shows a schematic representation of a thread traversing device 100 at a work station 200 of a textile machine 300 in a production state I. By way of example and schematically, a thread traversing device 100 for a winding device, which can also be referred to as a work station 200 of a textile machine 300 producing cross-wound bobbins 30, is shown. The thread traversing device 100 is shown here in a schematic sectional view. The thread traversing device 100 has a thread guide housing 32 on which a thread guide 25 is arranged.

At least one vacuum system can be provided which has at least one fluid guide 6. The thread guide housing 32 is designed in such a way and a traversing device 38 is associated with the thread guide housing 32 so as to reversibly traverse the thread guide 25 in a work station 200 of the textile machine 300 along a direction of the axis of rotation of the cross-wound bobbin 30 to be produced. FIG. 1 shows a rotation in the forward direction VR for the winding drum 20 and the cross-wound bobbin 30. This forward rotation takes place about the corresponding axis of rotation.

Here the traversing device 38 is designed and arranged to reversibly traverse along a direction of the axis of the cross-wound bobbin 30 to be produced. The axis of the cross-wound bobbin 30 to be produced coincides in particular with the axis of rotation. The traversing direction here is out of the sectional plane (plane of the figure representation on the page) or into it. In other words, the traversing direction in the representation corresponds in particular to the perpendicular to the representation of the figure. The thread guide 25 is in particular arranged on the traversing device via a thread guide shoe 26 so as to follow the movement of the traversing device 38.

Examples of the traversing device 38 can be a traction means, such as an endless traction means, further in particular a belt, a V-belt, a toothed belt, a flat belt, but also a movable rod or plate. The rod or plate can also have wedges or teeth. At least one drive pinion (not shown) can be provided in order to initiate and carry out the traversing movement. In embodiments with an endless traction means, tensioning rollers (not shown) can be provided which hold the endless traction means in tension. Furthermore, sliding rollers (not shown) and deflection rollers (not shown) can be provided which enable the endless traction means to run.

The thread guide housing 32 is designed in particular to be able to be brought into fluidic communication with the fluid guide 6 in order to apply a vacuum to the thread guide housing 32. In the production state I, or here in FIG. 1, the control valve 8 is in a closed state 8a. As a result, no vacuum can be applied to the thread traversing device 100. Here it is also the case that no vacuum is applied to the thread guide housing 32. However, the thread guide housing 32 can be provided with a short-circuit connection 52 in order to apply a vacuum to the thread guide housing 32 even outside a production interruption, as shown in FIGS. 2 and 3. The fluid guide 6 can be closable in the direction of the thread traversing device 100. In order to apply a vacuum at the thread guide housing 32 separately from other regions of the thread traversing device 100, in particular separately from a stationary air duct 58 that guides a thread 2, as described in detail elsewhere, the fluid guide 6 can be closable in the direction toward the thread traversing device 100. Corresponding valves and throttle points are not shown here. In other words, this means that further throttle points, such as the control valve 8, can also be provided in order to enable a separate application of vacuum, but also a simultaneous application of vacuum at the thread traversing device 100 and the thread guide housing 32.

Alternatively, a functional spatial separation of the application of a vacuum to the thread guide housing 32 and other regions of the thread traversing device 100 can be provided. This can take place via a pump 54, which is connected separately and/or directly to the thread guide housing 32 via at least one valve (not shown).

A vacuum can thereby be applied separately from a possible application of a vacuum to the air duct 58, as described elsewhere. As a result, cleaning cycles 510 can be implemented as described in more detail with reference to FIG. 5.

As already mentioned, the thread traversing device 100 can have an air duct 58. This can be arranged behind a cover 48. This can in particular be designed as a stationary air duct 58. The stationary air duct 58 is in particular designed and arranged in order to supply the thread 2 to the thread guide 25 in a production state I. In a non-production state, in particular a thread-seeking state II (see FIG. 2) or a piecing state III (see FIG. 3), the air duct 58 can be connectable to the at least one fluid guide 6 of the vacuum duct 4 in order to form a fluidic communication via the air duct 58 to the thread guide housing 32. Alternatively, the air duct 58 can be formed and arranged to bring the suction nozzle 50 and the thread guide housing 32 into fluidic communication with the vacuum duct 4. In particular, fluidic communication is a state in which a fluid can have a connection and thus an expansion space via the conduit systems and/or the device itself. A fluid can be air to be suctioned off, but also a process fluid. The latter can be provided for example for flushing the textile machine, for example when the yarn has to be kept particularly dry. In such a case, dry air, artificial air, or nitrogen can be used.

The vacuum duct 4 has in particular a suction nozzle 50. This can in particular be designed as a stationary suction nozzle 50. The suction nozzle 50 is in particular designed and arranged in such a way as to find a thread end 57 on the cross-wound bobbin 30 and to suction it into the suction nozzle 50. For this purpose, the suction nozzle 50 can be connected to the at least one fluid guide 6 in order to form a fluidic communication with the suction nozzle 50 in order to apply a vacuum at the suction nozzle end 68. In a state, the thread guide housing 32 can be reversibly brought into fluidic communication with the fluid guide 6, in particular at a time at which the suction nozzle 50 is active. It is thereby possible to clean the thread guide housing 32 while the suction nozzle 50 is active.

FIG. 2 shows a corresponding thread-seeking state II. FIG. 2 in particular shows the same embodiment as FIG. 1, but in a different operating state. The thread 2 is shown here as a broken thread whose thread end 57 has been picked up by the suction nozzle 50 on the cross-wound bobbin 30 and suctioned in. In particular, this is where the term “thread-seeking state II” originates. In a thread-seeking state II, the spinning device 400 is in a non-production state 400b. Accordingly, no thread 2 is supplied.

The fluid guide 6 can be designed as a vacuum duct 4 which has at least one control valve 8. By opening the control valve 8 from a closed state 8a into an open state 8b, a vacuum is applied at the suction nozzle 50. By a movement of the suction nozzle 50 relative to the cross-wound bobbin 30, the thread end 57 can be found and suctioned in a direction 36. This direction follows a fluid flow direction 18. The thread end 57 can be introduced into the fluid guide 6. The tension on the thread 2 can also be adjusted by throttling the control valve 8 accordingly.

Alternatively or additionally, the fluid guide 6 can also have a thread clamping device 10. The thread clamping device 10 can ensure that the thread 2 does not penetrate too deeply into the vacuum duct 4. The thread clamping device 10 can ensure that the thread 2 is held under tension, for example in order to bring the thread 2 back into a piecing position III, as shown in FIG. 3.

A closure device 12 can change from an open state 12a to a closed state 12b in order to close a thread entry region 17 into the air duct 58. For this purpose, the closure device 12 can be rotatably mounted in order to carry out a rotation in a direction of rotation 14. This allows the vacuum to build up. Furthermore, a fluid flow direction running in the direction 18 can thereby form which also introduces the thread 2 into the fluid guide 6 with its thread end 57.

As a result, the thread 2 can interact in a thread region with a thread-catching device 16, which is arranged on the closure device 12, in such a way as to catch the thread region of the thread 2. Here, for reasons of representation, no direct interaction between the thread 2 and the thread-catching device 16 is shown. In one embodiment, the thread 2 can be guided through the thread entry region 17 again by rotation of the closure device 12. In doing so, it can be supplied to a loop formation through which a reattachment to a subsequently supplied thread (not shown) can take place.

The closing device 12 can be designed and arranged to close the thread entry region 17 into the air duct 58 in a non-production state, in particular the thread-seeking state II, as shown in FIG. 2 and described above, but also in a piecing state III, as shown in FIG. 3 and described with reference thereto. The fluid guide 6 is designed and arranged to connect the vacuum system to the air duct in order to form a fluidic communication with the suction nozzle 50, as already described. The thread guide housing 32 is designed and arranged in particular in such a way as to be connected to the fluid guide 6 in the non-production state in order to generate a fluid flow 18 through the suction nozzle 50 and simultaneously out of the thread guide housing 32. The thread guide housing 32 has a reversibly closable opening 44a, 44b, through which a fluidic communication can take place between the interior of the thread guide housing 32 and the vacuum system via the air duct 58 and the fluid guide 6 when the control valve 8 is open. For this purpose a fluid flow 24 is formed in the thread guide housing 32, particularly in the open state 44b.

Additionally or alternatively, the thread guide housing 32 can have a short-circuit connection 52 to the fluid guide 6, via which a fluidic communication can be formed without establishing a connection via the air duct. The resulting fluid flow direction in the thread guide housing 32 can deviate from the fluid flow direction 24 with simultaneous cleaning.

Additionally or alternatively, a vacuum can be applied to the thread guide housing 32 independently of a vacuum at a suction nozzle 50. For this purpose, a separate pump 54, which can be part of the vacuum system, can be provided which enters into fluidic communication with the interior of the thread guide housing 32 via a valve (not shown).

Additionally or alternatively, the fluid flow 24 in the thread guide housing 32 can be maintained in the thread guide housing 32 by a thread guide housing flow device, in particular by at least one opening (not shown) in the thread guide housing 32 and/or by at least one nozzle 46, while a vacuum is applied to the thread guide housing 32.

In addition to or independently of the embodiments described here, the thread traversing device 100 can have a vacuum system which is designed in such a way as to apply a vacuum from the outside to the thread guide housing 32 via the fluid guide 6. This vacuum can in particular be applied in such a way to generate a fluid flow along the thread guide 25.

FIG. 3 shows a piecing process III as a non-production state of an embodiment corresponding to the embodiment shown in FIG. 1 and FIG. 2. For reasons of clarity, the cross-wound bobbin 30 is not shown here. In contrast, a support roller 22 for the winding drum 20 is shown. This may already be present in the previous embodiments, but is not shown there for reasons of clarity.

A preparatory piecing process III can be carried out if there is a thread breakage of the thread 2. In this case, the rest of the thread is drawn into the vacuum duct 4 by a thread end 57 in a first direction 36, as described in detail elsewhere. Furthermore, the thread 2 is inserted with its second thread end 66 into a process duct 60. Here as well, a vacuum is applied in order to thus fix the thread 2 at its two thread ends 57, 66. This can be done in particular by two harmonizing vacuum sources 4 or by suitably equipped thread clamping devices 10. The thread is prepared in order to initiate a piecing process III and thus to initiate a linking of the thread 2 to a thread (not shown) to be subsequently delivered. The vacuum, which is applied to the thread guide housing 32, is applied to the thread guide housing 32, in particular via a closable opening 44b, in order to (simultaneously) carry out a cleaning of the thread guide housing 32.

Alternatively or additionally, a preventative cleaning can also take place. In this case, it may be that there is no thread in the system, or a purely preventive cleaning is being carried out, which is independent of the non-production states described here. In these cases the cleaning of the thread guide housing 32 can take place as described elsewhere. For this purpose, a cleaning cycle 510 can be performed as described with respect to FIG. 4.

FIG. 4 shows a schematic representation of a method 500 for cleaning a thread guide housing 32. In particular, this can be a thread guide housing 32 as has already been described in detail.

In particular, the method 500 comprises a step of stopping 502 a spinning device 400. This step can be omitted in a cleaning cycle 510, which can be a preventive cleaning. Here the cleaning of the thread guide housing 32 can take place during a production state I. In a cleaning cycle 510, the following steps are run through cyclically. The start of each run can be set depending on a time or depending on an event.

The method comprises in particular the step of establishing 504 a fluidic communication between at least one vacuum system and the thread guide housing 32. Furthermore, it can comprise the step of applying 506 a vacuum to the thread guide housing 32. Corresponding settings and changes are made here as described with reference to FIGS. 2 and 3.

The method can have a step of resuming 508 a production. The winding process can thereby be continued and completed. In the case of acyclic cleaning steps, the method ends in particular with the resuming 508, but the method can be resumed. For cleaning cycles 510, which can take place independently of the step of switching off the spinning device 400, the step of resuming 508 is not provided because production can take place continuously.

The method 500 can be designed such that a plurality of vacuum systems are provided and wherein one of the vacuum systems is activated depending on a preceding or subsequent working state, in particular depending on the type of the thread 2, in order to apply a vacuum. As a result, impurities which arise in different work processes can be separated from one another. This can also relate, for example, to the presence of impurities which result from different types of threads.

In FIG. 1 to 3, in addition a control device 70 is designed and configured to carry out a method 500 as described. The components correspondingly listed above, such as valves, pumps, openings, throttles, etc., are controlled and monitored so that the method result can be provided.

The control device 70 can be a computing unit, a computer, a processor, and/or a CPU. A computer program product can be executed thereon that includes machine-readable instructions that, when executed on a control device 70, enable the corresponding commands to be generated and executed in order to perform a described method by correspondingly controlling a described device or described system.

“Can” in particular refers to optional features of the invention. Accordingly, there are also developments and/or exemplary embodiments of the invention which additionally or alternatively have the respective feature or the respective features.

From the combinations of features disclosed in the present case, isolated features can also be taken as needed and used by resolving a structural and/or functional relationship possibly existing between the features in combination with other features for delimiting the subject matter of the claim.

### LIST OF REFERENCE SIGNS

2 Thread
4 Vacuum duct
6 Fluid guide
8 Control valve
8a Closed state
8b Open state
10 Thread clamping device
12 Closure device
12a Open position of closure device
12b Closed position of closure device
14 Direction of rotation
16 Thread-catching device
17 Thread entry region
18 Fluid flow
20 Winding drum
22 Support roller
24 Fluid flow in the thread guide housing
25 Thread guide
26 Thread guide shoe
30 Cross-wound bobbin
32 Thread guide housing
34 Direction of movement in the production state
36 Direction of movement in the thread catch state
38 Traversing device
44a Closed opening from the air duct into the thread guide housing
44b Opened opening into the thread guide housing/connection
46 Nozzle
48 Cover
50 Stationary suction nozzle
52 Short-circuit connection
54 Pump/separate connection
56 Toothed belt/flat belt
57 (First) thread end
58 Stationary air duct
60 Process duct
62 Control valve open
64 Fluid flow for spinning
66 (Second) thread end
68 Suction nozzle end
70 Control device
100 Thread traversing device
200 Winding device/work station
300 Textile machine
400 Spinning device
400a Spinning device in operation
400b Spinning device at rest
500 Method for cleaning a thread guide housing
502 Placing a spinning device
504 Establishing a fluidic communication
506 Applying a vacuum
508 Resumption of production
510 Cleaning cycles
I Production state
II Thread-seeking state
III Preparatory spinning process
VR Forward direction
RR Rearward direction

1. A thread traversing device for a winding device of a textile machine producing a cross-wound bobbin, the thread traversing device comprising:
a thread guide housing having a thread guide;
a traversing device designed and arranged to reversibly traverse along a direction of an axis of the cross-wound bobbin to be produced; and
at least one vacuum system comprising at least one fluid guide;
wherein the thread guide housing is designed and wherein the traversing device is associated with the thread guide housing so as to, at a work station of the textile machine, reversibly traverse the thread guide along a direction of an axis of rotation of the cross-wound bobbin to be produced; and
wherein the thread guide housing can be brought into fluidic communication with the at least one fluid guide in order to apply a vacuum to the thread guide housing.

2. The thread traversing device according to claim 1, wherein the at least one vacuum system has a suction nozzle designed and arranged in such a way as to find a thread end on the cross-wound bobbin; and
wherein the suction nozzle is connected to the at least one fluid guide to form a fluidic communication with the suction nozzle; and
wherein the thread guide housing in a state can be brought into fluidic communication with the at least one fluid guide in a reversible manner.

3. The thread traversing device according to claim 2, further including an air duct which is designed and arranged in order to feed thread to the thread guide in a production state, and wherein the air duct can be connected to the at least one fluid guide of the at least one vacuum system in a non-production state in order to establish a fluid communication via the air duct to the thread guide housing; or
wherein the air duct is designed and arranged to bring the suction nozzle and the thread guide housing into fluidic communication with the at least one vacuum system.

4. The thread traversing device according to claim 1, wherein the at least one fluid guide is designed as a vacuum duct which has at least one of a throttle point and/or a thread clamping device.

5. The thread traversing device according to claim 3, further including a closure device designed and arranged to close a thread entry region into the air duct.

6. The thread traversing device according to claim 5, further including a thread-catching device arranged on the closure device to catch a thread region of a thread.

7. The thread traversing device according to claim 5, wherein the closure device is designed and arranged to close the thread entry region in the air duct in the non-production state;
wherein the at least one fluid guide is designed and arranged to connect the at least one vacuum system to the air duct in the non-production state in order to establish a fluidic communication with the suction nozzle; and
wherein the thread guide housing is formed and arranged to be connected to the at least one fluid guide in the non-production state to generate a fluid flow through the suction nozzle and simultaneously out of the thread guide housing.

8. The thread traversing device according to claim 1, wherein:
the thread guide housing has a reversibly closable opening; and/or
the thread guide housing can be connected to the at least one fluid guide via a short-circuit connection; and/or
the vacuum can be applied to the thread guide housing independently of a vacuum at a suction nozzle; and/or
fluid flow in the thread guide housing can be maintained in the thread guide housing by a thread guide housing flow device while the vacuum is applied to the thread guide housing.

9. The thread traversing device according to claim 1, wherein the at least one vacuum system is designed in such a way that, via the at least one fluid guide, the vacuum is applied to the thread guide housing from an outside thereof as to generate a fluid flow along the thread guide.

10. A thread guide housing for the thread traversing device according to claim 1.

11. A textile machine comprising the thread traversing device according to claim 1 and/or comprising a thread guide housing for the thread traversing device.

12. A method for cleaning the thread guide housing according to claim 10, wherein the method comprises the steps:
producing a fluidic communication between the at least one vacuum system and the thread guide housing; and
applying the vacuum at the thread guide housing.

13. The method according to claim 12, wherein the at least one vacuum system comprises a plurality of vacuum systems, and wherein one of the plurality of vacuum systems is activated depending on a preceding or subsequent working state in order to apply vacuum.

14. A control device designed and configured to carry out the method according to claim 12.
